(19) United States
(12) Patent Application Publication
(10) Pub. No.: US 2018/0325312 A1
(43) Pub. Date: Nov. 15, 2018

(54) Double-Sided Electric Grill

(71) Applicant: NuWave, LLC, Libertyville, IL (US)

(72) Inventors: Jung S. Moon, Long Grove, IL (US); Jian Jiang Liu, Jiangmen City (CN); Bao Quan Yu, Lunjiao Town (CN)

(21) Appl. No.: 15/866,056

(22) Filed: Jan. 9, 2018

Related U.S. Application Data
(60) Provisional application No. 62/443,876, filed on Jan. 9, 2017.

(51) Int. Cl. A47J 37/06

(52) U.S. Cl. CPC A47J 37/0611

(57) ABSTRACT

An electric grill used to cook food items positioned between upper and lower grilling surfaces is disclosed. The electric grill includes a base portion having outer surfaces and a first inner grilling surface contained therein, an lid portion pivotably connected to the lower base portion and having outer surfaces and a second inner grilling surface contained therein, a handle functionally connected to the lid portion to pivot the lid portion between an open position and a closed position, and an electronic control interface positioned on the handle configured to control the operation of the first and second inner grilling surfaces.

### RELATED APPLICATIONS

This application the filing priority of U.S. Provisional Application Serial No. 62/443,876 title “Double-Sided Electric Grill” and filed on Jan. 9, 2017. The '876 application is hereby incorporated by reference.

### TECHNICAL FIELD OF THE INVENTION

The present invention relates to indoor grilling appliances. Specifically, the invention relates to a double-sided indoor grilling appliance.

### BACKGROUND OF THE INVENTION

Electric indoor grills have managed to bring the joy of outside cooking, specifically grilling, into people's homes. Whenever temperatures and/or inclement weather make outdoor cooking impossible or at least impractical, electric grills can help save the day. Further, even those without a backyard, a patio or a nearby park, can experience grilled food from the comfort of their own apartment, condo or wherever.

However, a drawback of many electric grills, much like the old-fashioned, outdoor grills, is the lack of precise temperature control. High, medium and low settings can leave a lot of guesswork for the cook. Further, typical grills cook only from below the cooking grate, requiring greater involvement of a cook to turn food items to insure they achieve a proper level of doneness. Also, while most outdoor grills provide a lid to hold in some of the smoke for added flavor, it can be difficult to check on items when the lid is closed.

Until the invention of the present application, these and other problems in the prior art went either unnoticed or unsolved by those skilled in the art. The present invention provides an electric indoor grill which performs multiple cooking functions without sacrificing taste, flavor, portability, style or affordability.

### SUMMARY OF THE INVENTION

There is disclosed herein an improved electric grill which avoids the disadvantages of prior devices while affording additional structural and operating advantages.

Generally speaking, the electric grill comprises a base portion having outer surfaces and a first inner grilling surface contained therein, a lid portion pivotably connected to the base portion and having outer surfaces and a second inner grilling surface contained therein, a handle functionally connected to the lid portion to pivot the lid portion between an open position and a closed position, and an electronic control interface. Coupled within the first and second inner grilling surfaces are the first and second heating elements. A electronic control interface is positioned on the handle configured to control the operation of the first and second inner grilling surfaces via the first and second heating elements.

In a preferred embodiment, both the first and second grilling surfaces can be controlled separately at the electronic control interface. That is, the temperature of each may be separately set by the user.

In various embodiments of the electric grill, the electric control interface is comprised of pre-programmed settings. The user can select the pre-programmed settings or set cooking parameters of their own choosing.

In other various embodiments of the electric grill, a programming feature allows a user to set and store customized cooking parameters. For example, duration and time of each cooking surface can be set and stored into memory for later recall, as desired.

In other embodiments, the electric grill comprises a temperature probe detachably connected to the electronic control interface. The probe allows cooking to continue based on measure temperature of the food item by supplying feedback to the control interface.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a front perspective view of an embodiment of the disclosed electric grill;

FIG. 2 is a side perspective view of the embodiment shown in FIG. 1;

FIG. 3 is a close up of an embodiment of a handle, a electronic control interface, and a knob of the double-sided electric grill;

FIG. 4 is a close up of an embodiment of a handle connected to a base portion;

FIG. 5 is a front perspective view of the embodiment of a lid portion and base portion in a closed position.

FIG. 6 is a side perspective view of the embodiment of a lid portion and base portion in a open position.

FIG. 7 is a close up of an embodiment of a handle/electronic control interface of the double-sided electric grill;

FIG. 8 is an embodiment of a electronic control interface for the disclosed double-sided electric grill; and

FIG. 9 is an embodiment of a electronic control interface, and a high-temperature transparent panel.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

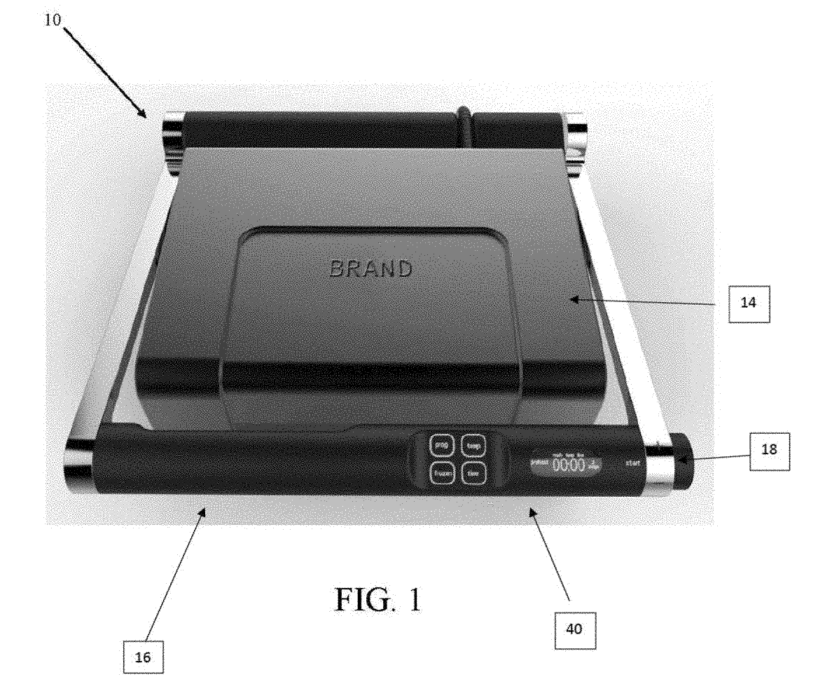

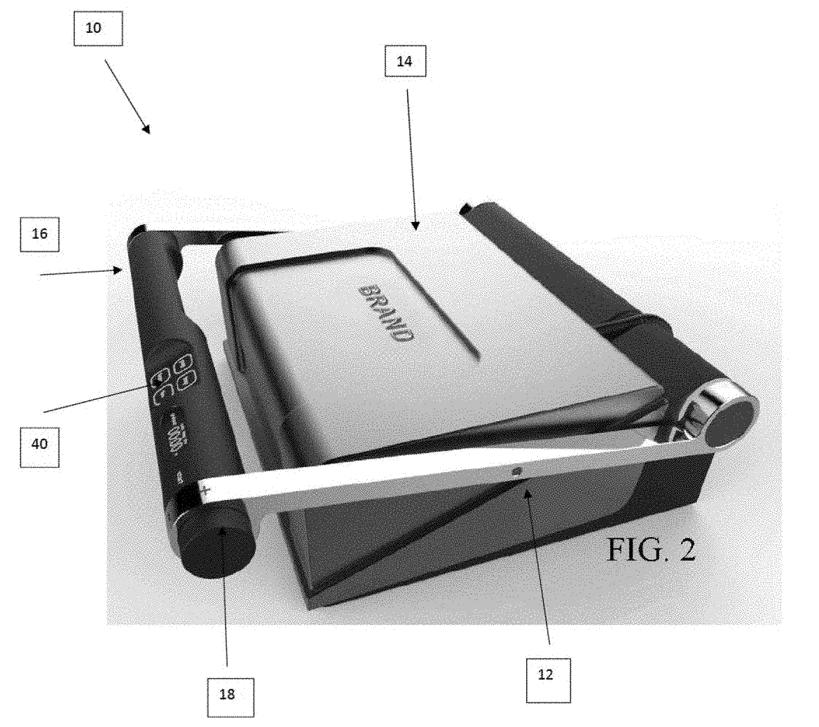

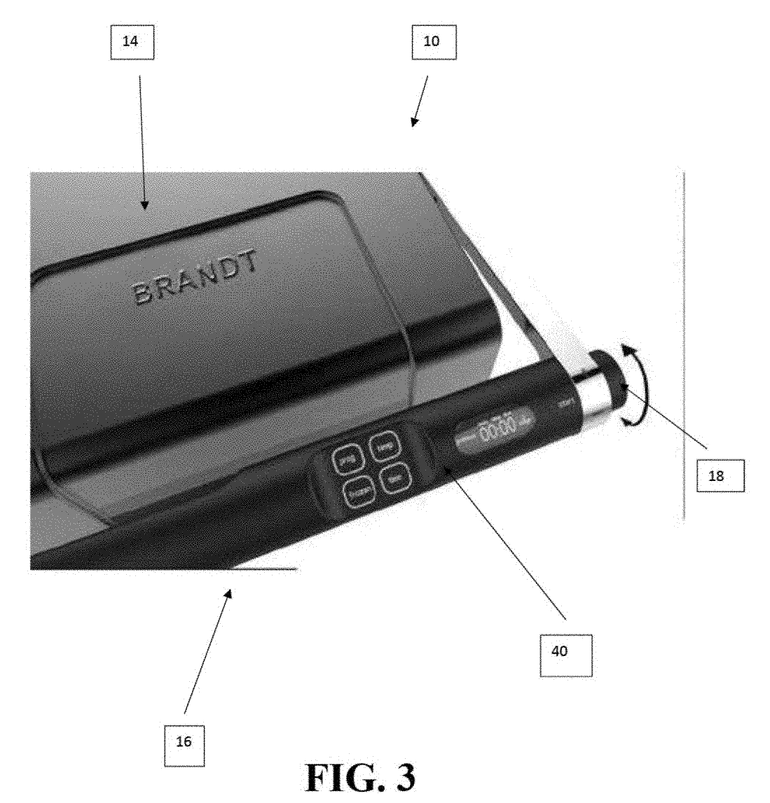

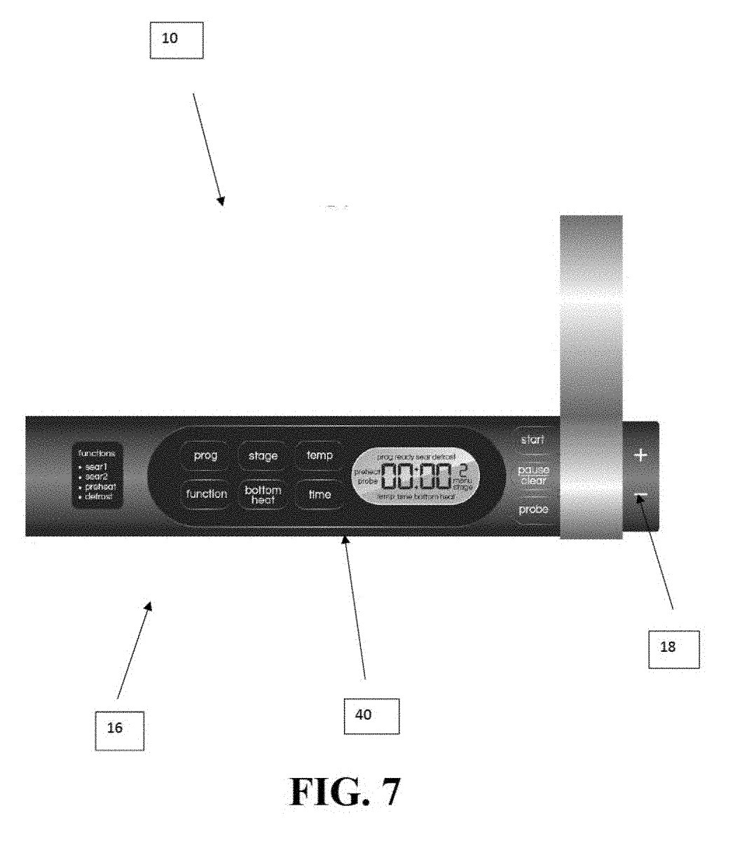

Referring to FIGS. 1-9, there is illustrated an exemplary embodiment of the double-sided electric grill 10 and its components. The double-sided electric grill 10 is comprised of base portion 12, a lid portion 14, and a handle 16. Preferably, most of these components are made of strong heat-resistant materials to withstand high grilling temperatures.

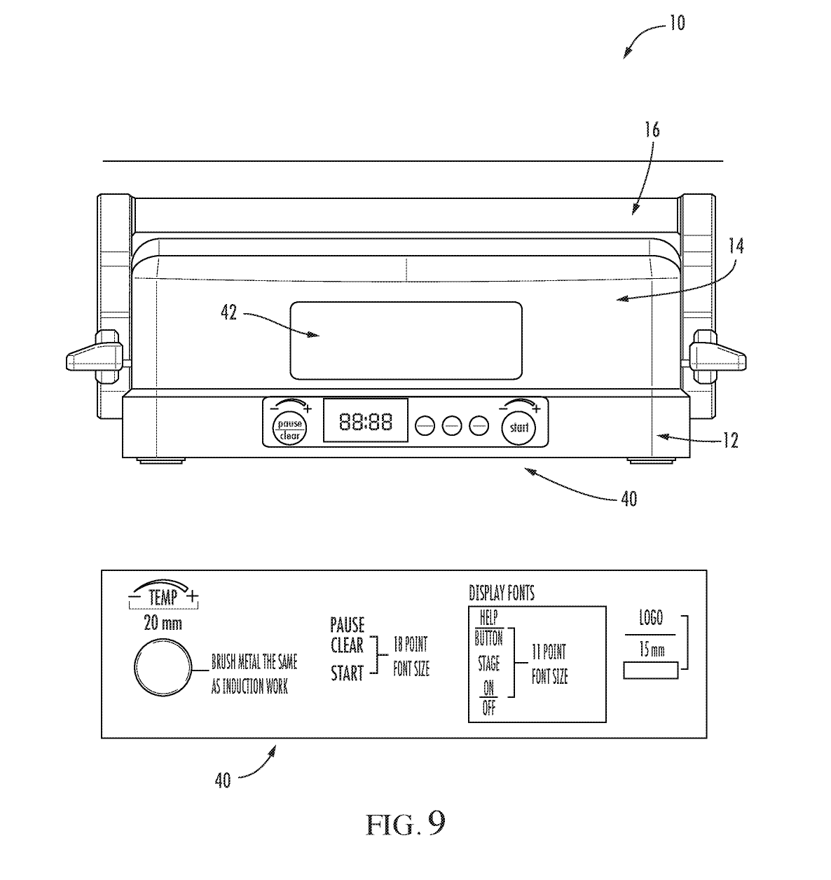

The double-sided electric grill 10 begins with the base portion 12 and a first inner grilling surface 22 coupled thereto. The first grilling surface 22 is made of a strong heat-resistant material, such as a cast iron metal, and is removable to be easily cleaned. The first grilling surface 22 is coupled to a first heating element 32. The first heating element 32 is contained within the base portion 12 and below the first grilling surface 22. Preferably, the first heating element 32 is made of a Nickel-Chromium (commonly referred to as NiChrome) material. The first heating element 32 independently heats the first grill surface 22 as controlled by a user electronic control interface 40. In an alternate embodiment of the double-side electric grill 10, the electronic control interface 40 is positioned on the base portion 12, as shown in FIG. 9.

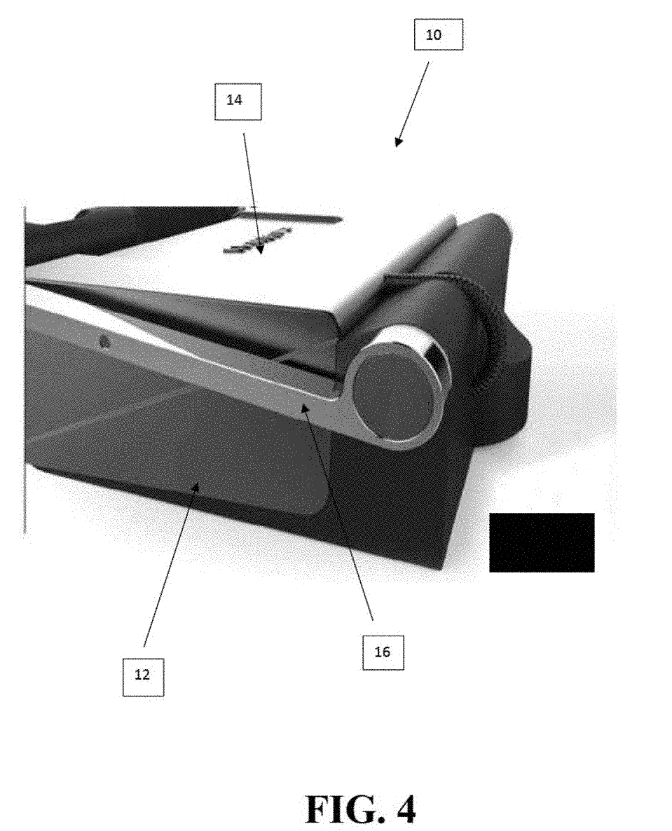

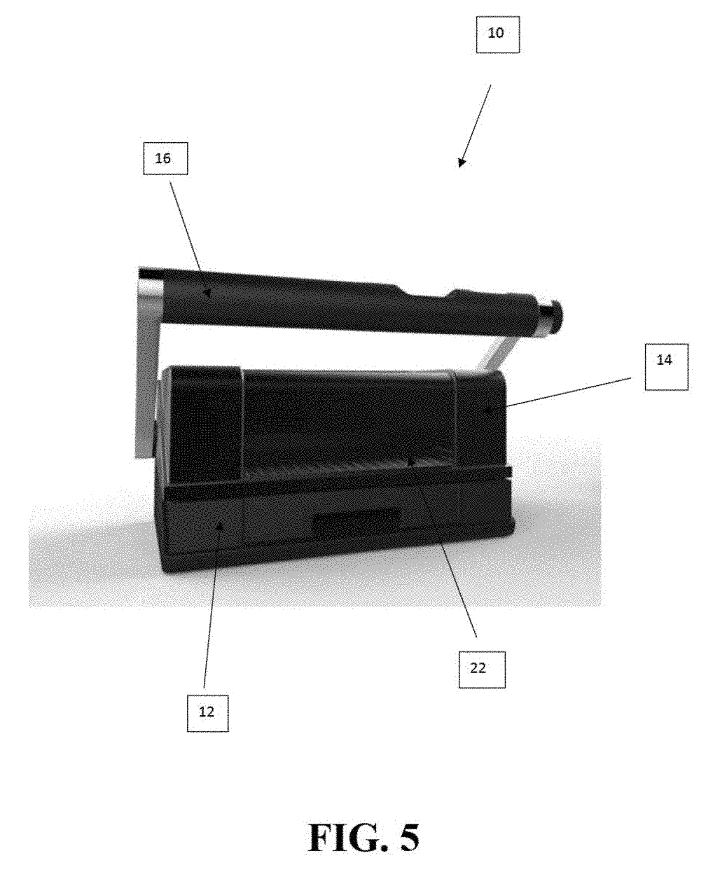

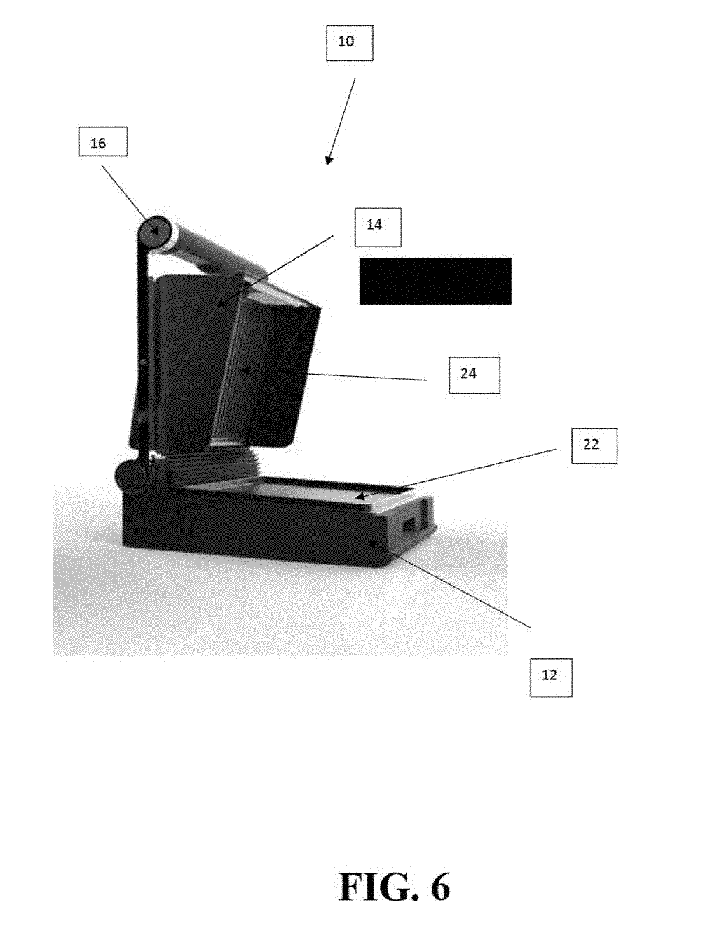

A lid portion 14 is pivotably connected along one end of the base portion 12, as shown in FIG. 4. The double-sided electric grill 10 is pivotably opened and closed at about a 90° angle as shown in FIGS. 5 and 6. The lid portion 14 is pivotably opened or closed along the base portion 12 by the handle 16. The lid portion 14 is also coupled to a second grilling surface 24.

The second grilling surface 24 is made of a strong heat resistant material such as a cast iron metal and is removable to be easily cleaned. A second heating element 34 is contained within the lid portion 14 and below the second grilling surface 24. Preferably, the second heating element 34 is made of the same NiChrome material as the first heating element 32. The second heating element 34 independently heats the second grilling surface 24 through the electronic control interface 40.

In another embodiment of the double-sided electric grill 10, a high-temperature transparent panel 42 is located on the lid portion 14 as seen in FIG. 9. The high-temperature transparent panel 42 is made of a strong heat resistant glass. The high-temperature transparent panel 42 allows for a user to see inside the double-sided electric grill 10 to help appropriately grill food.

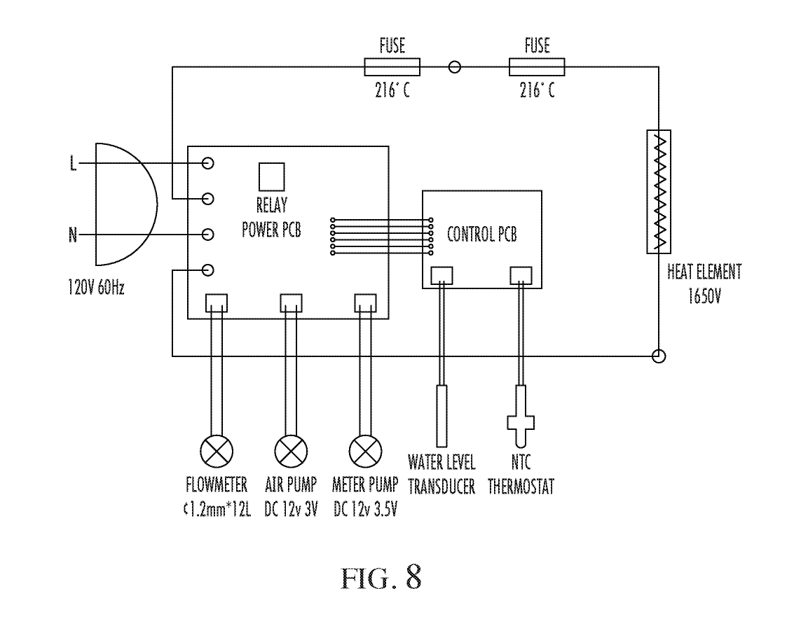

The handle 16 comprises a knob 18 which increases or decreases a temperature and cooking times for the double-sided electric grill 10. The knob 18 rotates along the handle 16 about 360° degrees. Inwardly rotating the knob 18 will increase a temperature or time settings of the electronic control interface 40, as shown in FIGS. 1 and 8. An inward direction is labeled by a (+) symbol on the knob 18. Conversely, outwardly rotating the knob 18 will decrease a temperature or time setting of the electronic control interface 40, also shown in FIG. 8. An outward direction is labeled by a (−) symbol on the knob 18.

As previously noted, an alternate embodiment of the double-sided electric grill 10 has the electronic control interface 40 located on the base portion 12 where a user can increase or decrease a temperature or time setting, as shown in FIG. 9.

The electronic control interface 40 is located on the handle 16 or the base portion 12. The electronic control interface 40 comprises circuitry for controlling operation of the double-sided electric grill 10 which includes an overheating safety feature comprised of first and second shutoff fuses or safety switches. The first and second safety fuses have a mechanism, as is well-known in the art, for stopping power to the heating elements when they reach a threshold parameter, such as a maximum temperature. Preferably, the first and second safety fuses are switches, or fuses, connected in series to establish a redundant safety mechanism. The first and second safety fuses redundant fuse configuration significantly reduces the possibility of motor overload and overheating during operation.

Another feature of the electronic control interface 40 is that it allows for separate control of temperature for the first inner grilling surface 22 and the second inner grilling surface 24 via the first heating element 32 and the second hearing element 34. Preferably, the electronic control interface 40 comprises a plurality of pre-programmed features. The pre-programmed features are controlled from the electronic control interface 40 and allow a user to set and store cooking parameters. For example, duration and time of each cooking surface can be set and stored into memory for later recall through the pre-programmed features.

In another embodiment of the double-sided electric grill 10, a temperature probe is detachably connected to the electronic control interface 40, or wherever is convenient on the double-sided electric grill 10.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. An electric grill comprising:
a base portion having outer surfaces and a first inner grilling surface coupled to a first heating element;
a lid portion pivotably connected to the base portion and having outer surfaces and a second inner grilling surface coupled to a second heating element;
a handle functionally connected to the lid portion to pivot the lid portion between an open position and a closed position;
a high-temperature transparent panel located on an outer surface of the lid portion; and
an electronic control interface positioned on the handle and configured to control operation of the first and second heating elements coupled to the respective inner grilling surfaces.

2. The electric grill of claim 1, wherein the electronic control interface separately controls a temperature of the first inner grilling surface via the first heating element.

3. The electric grill of claim 1, wherein the electronic control interface separately controls a temperature of the second inner grilling surface via the second heating element.

4. The electronic grill of claim 1, wherein the base portion includes a first protective surface which houses the first inner grilling surface.

5. The electronic grill of claim 1, wherein the base portion includes a second protective surface which houses the second inner grilling surface.

6. The electronic grill of claim 1, wherein the electronic control interface comprises a first safety fuse and a second safety fuse.

7. The electric grill of claim 1, wherein the electronic control interface comprises preprogrammed features.

8. The electric grill of claim 1, further comprising a temperature probe detachably connected to the electronic control interface.

9. The electric grill of claim 1, wherein the first inner grilling surface and the second inner grilling surface are removable.

10. The electric grill of claim 1, wherein the handle comprises a knob for increasing and decreasing a temperature and cooking times.

11. A double-sided electric grill comprising:
A base portion having a first protective surface and a first inner grilling surface contained therein;
wherein the first inner grilling surface comprises:
a first heating element coupled to the first inner grilling surface;
an lid portion pivotably connected to the base portion and having a second protective surface and a second inner grilling surface contained therein;
wherein the second inner grilling surface comprises:
a second heating element coupled to the second inner grilling surface;
a handle functionally connected to the lid portion to pivot the lid portion between an open position and a closed position;
wherein the handle comprises:
a knob for increasing and decreasing a temperature and cooking times.
a high-temperature transparent panel located on a front outer surface of the lid portion; and
an electronic control interface positioned on the handle and configured to separately the operation of the first and second inner grilling surfaces via the first and second heating element.
wherein the electronic control interface comprises:
a temperature probe detachably connected to the electronic control interface; and
a first safety fuse and a second safety fuse.

12. The double-sided electric grill of claim 11, wherein the first inner grilling surface and the second inner grilling surface are removable.

13. The double-sided electric grill of claim 11, wherein the electronic control interface comprises preprogrammed features.
